(19) United States
(12) Patent Application Publication
(10) Pub. No.: US 2002/0160242 A1
(43) Pub. Date: Oct. 31, 2002

(54) Device for providing an emergency electrical supply to auxiliary components of a nuclear power station and implementation method

(76) Inventor: Philippe Dagard, Marly Le Roi (FR)

Correspondence Address: Morris Liss, Connolly Bove Lodge & Hutz LLP, 1900 M Street, N.W., Suite 800, Washington, DC, 20036-3425, US

(21) Appl. No.: 10/120,781

(22) Filed: Apr. 12, 2002

(30) Foreign Application Priority Data
Apr. 13, 2001 (FR) 01 05142

(51) Int. Cl. H01M 8/04; H01M 8/12

(52) U.S. Cl. 429/22; 429/25

(57) ABSTRACT

The device for providing an emergency electrical supply comprises a fuel cell (2) supplied with hydrogen and with air or even with pure oxygen from special compressed air and hydrogen systems of the nuclear power station or from special oxygen systems. It may also be produced in the form of a hybrid system comprising the fuel cell (2) and a supercapacitor plant placed in parallel or in series with respect to the fuel cell and via a suitable interface (chopper, for example). The fuel cell may be a cell of the PEMFC type. The fuel cell may in particular provide the electrical supply to the motor of a pump for injecting water into the seals of a primary pump of a pressurized-water nuclear reactor. It may also be used for the purpose of supplying certain monitoring and control systems of the nuclear power station should the normal supply to these systems be lost. The power of the systems according to the invention may reach 500 kVA.

The invention relates to a device for providing emergency electrical supply to auxiliary components of a nuclear power station and in particular, to a power station comprising a pressurized-water-cooled nuclear reactor and a method to produce an emergency electrical supply, in the case of failure of the main electrical supply for the auxiliary components of the nuclear power station.

Many auxiliary components of a nuclear power station, used in particular for monitoring, control or protecting main components of the power station, must be continuously supplied with electric current in order to be able to carry out their functions during all the operational phases of the nuclear reactor of the power station.

For example, it must be possible for equipment such as circuit breakers and contactors, reversing contactors of motorized valves and solenoid valves fitted in the electrical buildings of a nuclear power station to be continuously supplied, in order to be available under any circumstance, so as to provide the satisfactory operation of a nuclear reactor.

This equipment is supplied, for example, with direct current at 125 V provided by the nuclear power station, from an alternating 380 V network and a rectifier. Should there be an incident or accident leading to an interruption of the electrical supply of the nuclear power station, it is necessary to keep the functions of the electrical equipment as defined above.

To provide the continuous operation under any circumstance of this electrical equipment, batteries such as lead or cadmium batteries-able to deliver, for example, a nominal voltage of 125 V with a maximum current of 250 A, are usually used.

Under normal operational conditions of the power station, the batteries do not produce any current except for occasional current consumption peaks resulting from supplying a high number of components.

Where the normal electrical supply of the power station is interrupted, the batteries alone must provide the energy supplied to the electrical equipment, it being possible for such an incident or accident to be, for example, a local failure of the means for supplying electrical equipment.

In this case, the batteries must be able to supply the electrical equipment for at least one hour without the voltage at the battery terminals going below a limiting voltage of about 105 V, the nominal voltage being 125 V.

The size and the mass of the batteries which can provide this function are extremely large, in order to reach the minimum desired operating life for the electrical supply.

Pressurized-water-cooled nuclear reactors comprise a reactor coolant system in which the pressurized water is circulated by, primary pumps comprising a pump impeller which is rotated inside the volute of the pump by a shaft connected to the pump motor.

The shaft of the primary pump passes through several series of seals between its part connected to the motor, at atmospheric pressure, and its end part connected to the pump impeller, inside the volute receiving water at very high pressure and at very high temperature.

In order to provide constant integrity of the seals, it is necessary to introduce pressurized water into the first series of seals, in order to prevent the successive destruction of the seals, causing a leak of reactor coolant outside the reactor coolant system.

It is therefore necessary to provide a continuous supply of cold water to the seals to prevent any risk of destruction and of reactor coolant leakage.

In normal operation, a high-power charging pump provides the supply of cold water to the seals. Where there is a loss of normal electrical supplies, the water is injected into the first series of pump seals by a positive-displacement pump driven by an electric motor which is generally supplied with three-phase 380 V alternating current.

When the 380 V current provided by the power station is interrupted (main network, auxiliary network and motor-generator sets), it is necessary to provide an emergency supply for the motor of the pump injecting water into the seals of the primary pump.

It has been proposed, for example, to use turbine generators supplied by the steam generators of the nuclear power station which are started up in the case of incident or accident leading to an interruption in the electric current supply of the injection pump.

The time needed to startup the turbine generators may lead to an injection fault in the seals of the primary pump. Furthermore, the turbine generators must be checked periodically and their maintenance can be expensive.

The startup of the turbine generators for producing drive current for the injection pump must be carried out within a maximum time period of two minutes after the loss of the normal electrical supplies, which corresponds to the maximum time of operation of the primary pump without supplying the seals with pressurized water. This time period is defined to prevent any thermal shock to the alumina coatings of the seals of the number 1 series of primary pumps.

Experience has demonstrated that turbine generators driven by steam taken from the steam generators may have some failures on startup, due in particular to the presence of water in the systems.

It is therefore desirable to have available means for the emergency electrical supply of auxiliary components of a nuclear power station which can be easily integrated into the systems and components of the power station, which have an operating life greater than that of batteries and which can be put in service quickly and safely.

The aim of the invention is therefore to provide a device for the emergency electrical supply of auxiliary components of a nuclear power station, which is of small size, very safe in operation and which has a good operating life, while requiring few maintenance operations.

With this aim, the device for the emergency electrical supply according to the invention comprises at least one fuel cell supplied with gas containing hydrogen and with gas containing oxygen from at least one reserve and at least one system of gas containing hydrogen and of gas containing oxygen, respectively.

In order for the invention to be better understood, an electrical supply device according to the invention and its use for the emergency supply of a pump for injecting water into the seals of a primary pump or for a switchboard for monitoring and control will now be described by way of example, with reference to the appended figures.

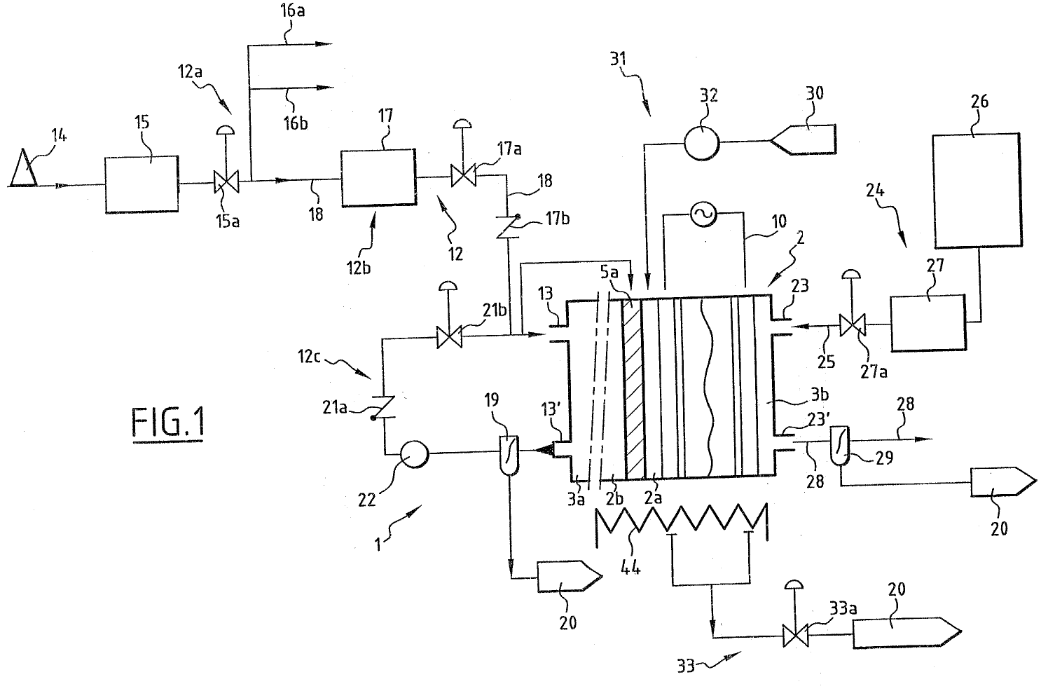

FIG. 1 is a diagram showing the set-up of an emergency electrical supply device consisting of a fuel cell, in the systems of a nuclear power station comprising a pressurized-water nuclear reactor.

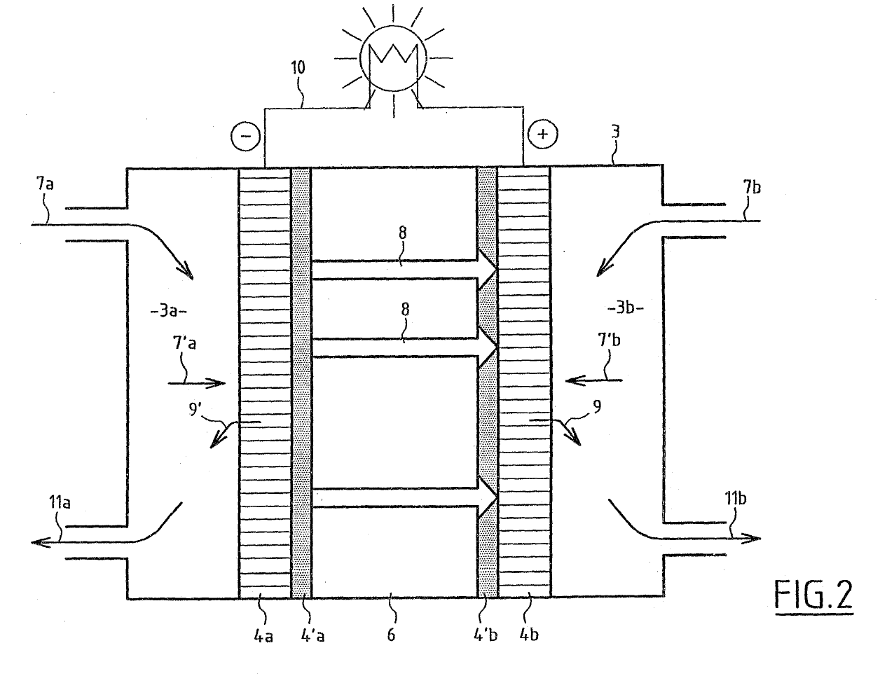

FIG. 2 is a schematic view showing the theoretical construction of a fuel cell using hydrogen as a fuel.

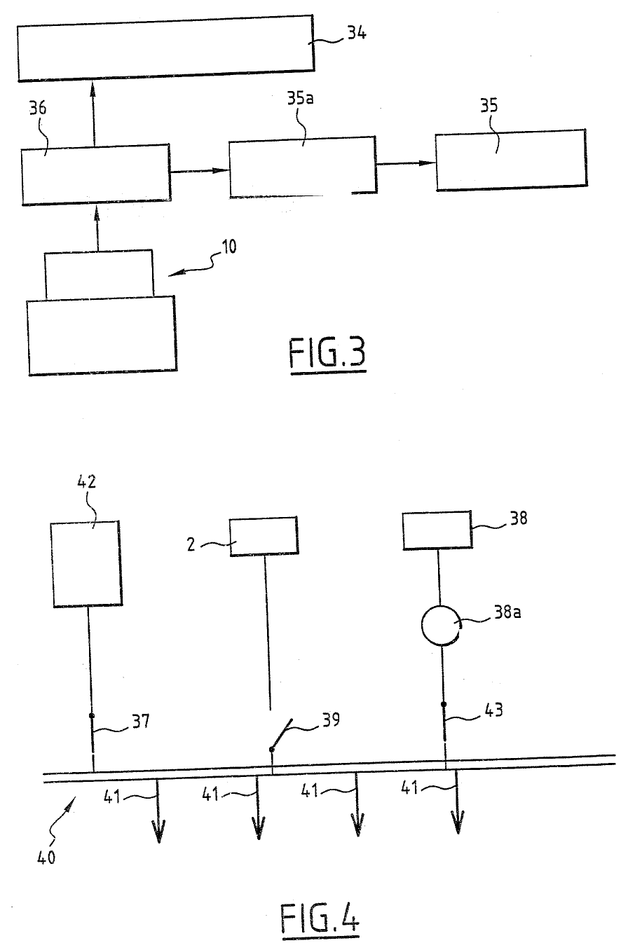

FIG. 3 is a diagram showing the use of the emergency electrical supply device of FIG. 1 to supply a pump for injecting water into the seals of a primary pump of the nuclear reactor and auxiliaries of the system for injecting into the seals of the primary pump.

FIG. 4 is a detailed diagram of the electrical supply of an electrical switchboard for components of a nuclear power station.

In FIG. 1, an emergency electrical supply device according to the invention, denoted generally by the reference 1, is shown schematically, together with the tanks and systems of the nuclear reactor used to operate the electrical supply device using a fuel cell.

The device 1 mainly comprises several elements forming fuel cells such as 2a and 2b placed in series and forming several stages of electric current production.

In addition, the device 1 comprises different systems intended for the supplying of hydrogen and oxygen to the fuel cell unit, cooling the cells, recycling the hydrogen not used and removal of the water formed or introduced into the fuel cell unit, respectively.

FIG. 2 shows schematically one unit cell of a fuel cell of the PEMFC type using hydrogen as-a fuel and air as an oxidizer.

The cell 3 shown in FIG. 2 is a unit cell of a fuel cell intended to help understand the operation of the fuel cell.

The cell 3 comprises a hydrogen inlet compartment 3a, an air inlet compartment 3b and, between the compartments 3a and 3b, the elements of the cell consisting of a first electrode 4a (anode), a second electrode 4b (cathode) and between the electrodes 4a and 4b, a water-impregnated membrane 6 made of polymer forming a solid electrolyte. Catalyst 4′a (or 4′b) placed on the porous electrode 4a (or 4b) allows the gases passing through the cell 3 to pass.

The electrodes are produced by depositing a mixture of platinized carbon powder on a conducting carbon fabric. The anode 4a is supplied with hydrogen (or gas containing hydrogen) and the cathode 4b is supplied with gas containing oxygen, for example air.

The fuel cell makes it possible to directly convert the free energy of a chemical oxidation-reduction reaction into electrical energy using the hydrogen and oxygen introduced into the fuel cell.

On contact with the anode 4a, the hydrogen molecules are transformed into hydrogen ions (protons) with release of electrons.

The hydrogen ions pass through the electrolyte as shown by the arrows 8 in FIG. 2b, in order to arrive at the cathode 4b at which they are in the presence of hydrogen ions and oxygen molecules. Under the effect of the catalyst contained in the cathode 4b, the hydrogen ions reduce the oxidizing oxygen of the air introduced into the fuel cell with absorption of electrons. The reaction produces water in the form of steam, as shown by the arrow 9.

The electrons produced by the anode reaction may flow in a user circuit 10 of the fuel cell, up to the cathode 4b. In this way, a potential difference is obtained between the anode and cathode and a flow of current is obtained in the user circuit 10 of the fuel cell.

The theoretical potential of the fuel cell is 1.23 V, which corresponds to the oxidation-reduction potential of the O₂/H₂O pair.

Since it is necessary to take account of the losses inside the fuel cell, this voltage is in fact located between 0.6 V and 0.9 V per element as shown in FIG. 2.

The membrane 6 is a membrane of the cationic type, such that it lets through only the hydrogen ions H⁺ from the anode 4a in which the molecular hydrogen H₂ (arrow 7′a) is introduced. The oxygen O₂ from the air introduced into the second compartment 3b of the fuel cell 3 is introduced into the cathode 4b, as shown by the arrow 7′b.

In fact, air introduced into the compartment 3b passes through the whole of the fuel cell and drives the steam or the water formed in the fuel cell, such that a mixture comprising steam or the water formed in suspension in the purging air is removed both through the compartment 3a and through the compartment 3b of the fuel cell, as shown by the arrows 11a and 11b.

In order to obtain enough electrical power from the fuel cell to provide an emergency electrical supply, it is necessary to juxtapose a plurality of unit cells as shown in FIG. 2.

For example, for an emergency supply for a pump for injecting into the seals of a primary pump, it is necessary to have available a power of about 150 kW which can be obtained by juxtaposing a number of unit cells, the number of which is defined by the d.c. voltage to be obtained and the cross section (electrode surfaces) of which is defined by the value of the current which must be produced.

For example, in order to obtain the power of 150 kW, it is possible to use two hundred and fifteen cells of the PEMFC type as shown in FIG. 2, the cross section of which has a width of 420 mm and a height of 420 mm.

A bipolar plate 5a, attached to an anode and a cathode of successive cells, respectively, is placed between two successive cells. The bipolar plates distribute the gases (hydrogen and oxygen) between the cells 3, collect electrons from one cell to the next and remove products formed by the reactions in the fuel cell (in particular steam), and remove the heat of reaction produced in the cell.

Each of the unit cells has a bipolar plate, an anode, a membrane and a cathode, the second bipolar plate being common to two successive juxtaposed cells.

A PEMFC cell of the usual type has a thickness of about 10 mm, such that, given the dimensions of the end compartments, the whole of the fuel cell has a length of about 2300 mm.

A very large number of units such as 2a and 2b, shown in FIG. 1, are therefore juxtaposed in order to form a fuel cell 2 having the desired electrical characteristics to provide the emergency electrical supply.

The fuel cell is supplied with hydrogen and air, at the ends of each cell, at a bipolar plate or the compartments 3a and 3b.

The hydrogen for the compartment 3a and the bipolar plates is supplied via a hydrogen system 12 connected to an inlet nozzle 13 of the compartment 3a of the fuel cell and to the bipolar plates such as 5a.

Nuclear power stations generally have their own means for the storage and distribution of hydrogen, which form a first part 12a of the system 12 for supplying hydrogen to the fuel cell.

This part 12a of the system 12 comprises one or more hydrogen storage tanks 14 under high pressure (for example 197 bar), a stage 15 for reducing the hydrogen pressure down to a distribution pressure (for example 7 bar) and a shutdown valve 15a to distribute the hydrogen, for example in the chemical and volume control system of the nuclear reactor (arrow 16a) or in a user circuit of the power station plant operator (arrow 16b).

The system 12 for supplying the fuel cell 2 is, for example, made by attaching to the part 12a of the existing hydrogen system of the nuclear power station, a part of the system 12b comprising a second stage 17 for reducing the pressure of the hydrogen (for example down to 3 bar), a shutdown valve 17a, a nonreturn valve 17b and a pipe 18 for joining the part 12a of the system downstream of the valve 15a to the nozzle 13 of the fuel cell.

In addition, the system 12 for distributing hydrogen comprises a recycling part 12c, which recovers hydrogen not consumed in the fuel cell, via a second nozzle 13′ of the first compartment 3a, the recovered hydrogen being reintroduced into the pipe 18 connected to the hydrogen inlet nozzle 13 in the first compartment 3a.

The recovery system 12c comprises a separator 19 making it possible to separate excess hydrogen from the steam formed in the fuel cell, the steam being condensed then removed into a drainage recovery system 20 from the nuclear reactor.

A nonreturn valve 21a, a shutdown valve 21b and a circulation pump 22 supplied electrically by the fuel cell, are also placed in the hydrogen recovery system 12c.

Depending on the power required from the fuel cell, a greater or lesser amount of hydrogen is recovered, which can be recycled such that the amounts of hydrogen taken from the storage reserve 14 are reduced.

In this way, it is possible to adjust the operation at power of the emergency supply device and to optimize hydrogen consumption.

Instead of the power station hydrogen supply, it could be possible to use a hydrogen system specific to the fuel cell.

The air supply for the second compartment 3b of the fuel cell and for the bipolar plates providing oxidizing oxygen and purging the fuel cell, is supplied by a system 24 connected to a nozzle 23 of the second compartment 3b by a pipe 25. The system 24 comprises a tank 26 of compressed air which is a normal component used in a nuclear power station. For example, a buffer tank 26 of compressed air with a capacity of 4 m³ is used, making it possible to supply air to the cell at a pressure of 3 bar.

A stage 27 for reducing the pressure of the compressed air (for example down to a pressure of 3 bar) and a shutdown valve 27a are placed, on the pipe 25, between the tank 26 and the nozzle 23 for injecting air into the fuel cell. Instead of the air, it is possible to use a pure oxygen system comprising pressurized reserves (P=190 bar), one or two pressure-reducing devices and shutdown valves according to the same principle as the hydrogen distribution system.

The use of oxygen makes it possible to improve the efficiency of the fuel cell.

A system 28 connected to a nozzle 23′ emerging into the second compartment 3b of the fuel cell makes it possible to remove the steam formed in the fuel cell mixed with the air injected into the fuel cell via the system 24. The system 28 comprises a separator 29 making it possible to remove the water formed in the drainage recovery system 20 from the nuclear reactor.

The air separated from the steam is removed to the atmosphere by a discharge pipe from the system 28.

The fuel cell 2 is heated because part of the energy produced by the chemical reaction inside the fuel cell is released in the form of heat.

It is necessary to cool the fuel cell and for this, the cooling water from a demineralized water system 30 of the nuclear power station is injected into special pipes of the fuel cell, via an injection system 31 comprising a pump 32, supplied with current by the fuel cell, for making the demineralized water flow in the system 31 and the fuel cell. The demineralized water could also flow under the effect of gravity from a tank at a level greater than that of the fuel cell.

The water flowing in the fuel cell is recovered by a system 33 connected to the drainage recovery system 20 from the nuclear reactor.

The recovery system 33 comprises branches connected to the anode parts and to the cathode parts of the fuel cell 2 via bipolar plates. A shutdown valve 33a is placed in the system 33, so that when it opens, the recovered water is removed into the drainage system 20.

A device 44 for heating the fuel cell (shown in the form of a coil) makes it possible to keep the fuel cell at an operating temperature when the fuel cell is not used for the emergency electrical supply. In this way, the startup time of the fuel cell is reduced, when it becomes necessary to use it.

A circuit using the electrical current produced by the fuel cell is denoted by 10. The circuit is connected to the cathode and anode parts of the fuel cell via bipolar plates, such that a d.c. current flows in the user circuit 10 at a constant voltage.

The circuit for recovering the electrical current produced at a d.c. voltage by the fuel cell is connected, as shown in FIG. 3, to the components of the nuclear power station for which it is desired to provide continuity of the electrical supply in the case of an incident or an accident.

FIG. 4 shows normal and emergency supply means for an switchboard 40 and for components using electrical current such as solenoid valve coils, motors or contactors of the nuclear power station or else auxiliaries of the fuel cell (for example pumps), via circuits 41.

The normal supply means 42 of the board 40 comprise in particular a supply unit connected to a network providing alternating current to the nuclear power station and comprising a rectifier to obtain d.c. current, for example at a voltage of 125 V.

The emergency supply means comprise in particular the fuel cell 2 and a plant comprising at least one supercapacitor 38, the structural and functional characteristics of which will be described below. The fuel cell 2 and the supercapacitor plant 38 are connected in parallel to the switchboard 40 and to the general supply line connected to the circuits 41 and placed in series in the supply line, with respect to the normal supply 42.

Respective controlled circuit breakers or relays 37, 39 and 43 are placed on the branches connecting the normal supply 42, the fuel cell 2 and the supercapacitors 38 to the general supply line. When the normal supply to the board and user circuits is available, the circuit breakers 37 and 43 are closed and the circuit breaker 39 is open. The board 40 and the user circuits 41 are supplied by normal supply means 42.

The supercapacitor or supercapacitors 38 are kept charged.

Should there be a loss of normal supply, the emergency supply is put in service by opening the circuit breaker 37 and by closing the circuit breaker 39.

The board 40 and the user circuits 41 are supplied firstly by the supercapacitors 38 then by the fuel cell 2, which is started up to produce electrical current during the discharge of the supercapacitors 38. In this way, improved continuity of the electrical supply is provided. The supercapacitors are dimensioned to guarantee the supply to the board 40 during startup of the fuel cells.

The interface between the supercapacitors 38 and a set of electrical supply busbars is provided by a reversible chopper 38a which makes it possible to keep the voltage of the set of busbars constant during the discharge of the supercapacitors.

Depending on requirements, it possible to supply a direct or alternating current at any voltage, for example 220V, 125V, 48V or 30V, by using electronic conversion means which may comprise inverters, transformers or rectifiers or fuel cell units with suitable characteristics.

The circuit 10 of a fuel cell 2 may also supply, via an inverter (or several inverters), one or more low-voltage motors, for example using a 690V or 380V three-phase supply.

In particular, as shown in FIG. 3, the circuit 10 can be used to provide the continuity of water supply to the seals of at least one primary pump of the nuclear reactor, via the positive-displacement pump 35 made to rotate by the electric motor 35a, when there is an interruption in the normal electrical supply to the pump 35.

The electric motor 35a for driving the pump 35 is supplied with three-phase alternating current at a voltage of 380V, via a converter for converting the direct current provided by the circuit 10 of the fuel cell into three-phase alternating current.

The converter 36 consists of an inverter.

Preferably, supercacitors placed in parallel with respect to the fuel cell make a faster startup of the injection pump possible in the case of loss of normal supply, during startup and power build-up of the fuel cells.

The emergency electrical supply to the auxiliary components 34 and 35 of the nuclear reactor can be provided by the fuel cell provided the hydrogen fuel is available in the tanks of the nuclear power station.

The period of use of a fuel cell of the PEMFC type may be about at least 10,000 hours. As a result, the period of continuous use of the emergency supply device for each fuel cell is limited only by the hydrogen reserve.

Because the fuel cells may have high power densities, they could correctly supply the boards and circuits for extended periods completely independently.

The total size of a fuel cell able to supply a board and a set of user components is substantially smaller than the size of the batteries (220V, 125V, 48V or 30V) usually used, for operating lives of one hour. It is possible to use a (small size) fuel cell to supply each of the monitoring and control boards of the nuclear power station or, on the contrary, to use a fuel cell of much greater power and much larger size to supply a set of monitoring and control boards.

Another application of the fuel cell as an emergency supply means relates to supplying of the pump for injecting water into the seals of a primary pump, as described above.

Moreover, a fuel cell has the advantage of not requiring any external source of energy to startup or operate and thus of being completely independent.

Furthermore, the startup of the fuel cell is very quick and the fuel cell actually only operates when it is needed to provide electrical current to supply the auxiliary components of the nuclear reactor following the loss of electrical supply, which is advantageous for all the applications for which the fuel cell is used as an emergency electric energy source.

The invention is not limited to the embodiment which has been described.

In order to improve the dynamics of the emergency system, it is possible to use, as described above, a supercapacitor plant placed in series or in parallel with respect to the fuel cell. Such a plant makes it possible to provide instantaneously the power needed to the various user components, while the power of the fuel cell builds up. The supercapacitors also make it possible to provide power in the presence of a consumption peak. The invention may therefore use a hybrid system consisting of a fuel cell and one or more supercapacitors.

The terms supercapacitors is used for capacitors which can provide much higher power on discharge than conventional capacitors, with much higher time constants.

The supercapacitors which can be used for the invention are based on the double-layer capacitance principle. The supercapacitors consist of two porous electrodes, an electrolyte and a porous separator. The production of the capacitors may call on various technologies. The electrodes may be made of carbon, deposited polymers or hydrated metal oxides. The electrolyte used may be aqueous or of the organic type.

Generally, the supercapacitors used have the advantage of an excellent charge-discharge cyclability (>100,000), a small size and the need for only a little maintenance.

In all cases, the supercapacitors must be accompanied by circuits providing a charge between the phases of use.

It is possible to use, instead of the fuel cell of the PEMFC type, other types of fuel cell, for example, a fuel cell of one of the following types: alkaline fuel cell (AFC) with or without membrane, phosphoric acid fuel cell PAFC, molten carbonate fuel cell MCFC, solid oxide fuel cell SOFC or a direct methanol fuel cell DMFC. Similarly, it is possible to use any other electric energy storage device such as batteries instead of supercapacitors in order to provide an instantaneous supply to users in the case of normal supply loss.

However, cells of the PEMFC type, which consume only hydrogen and air or pure oxygen, are particularly well suited to be integrated into the systems of a nuclear power station.

It is possible to envisage using a gas or any other substance containing hydrogen which may be available in a system of a nuclear power station as a fuel for the fuel cell instead of pure hydrogen, in order to supply the fuel cell either directly or via a reformer.

Similarly, it is possible to use pure oxygen from a dedicated reserve, or else any other gaseous mixture containing various amounts of oxygen, instead of air.

However, the invention preferably uses a fuel cell which can be directly supplied with hydrogen or with gas containing oxygen from the systems of the nuclear power station.

The invention is not limited to the emergency supply of pumps for injecting water into the seals of the primary pumps of a pressurized-water nuclear reactor but can be applied to alleviate any loss of electrical supply in a nuclear power station and to provide a direct-current electrical supply to auxiliary components of the power station comprising small pumps or motors, circuit breakers, relays for automatic controllers or any other low-voltage equipment supplied with direct current or with alternating current.

The power of the plants supplied by the hybrid system, fuel cell+supercapacitor, may go up to 500 kVA.

It is thus possible to supply the pumps providing emergency feedwater to the steam generators of the reactor, in order to cool the reactor in the case of total loss of electrical supplies.

The motors for these pumps are supplied at 690 V.

So, for a reactor of recent design, the auxiliary feed water pumps are replaced by two emergency pumps which need to be supplied in these situations.

Currently, two diesel generators dedicated solely to the emergency supply function are provided. These small diesel engines could each be replaced by at least one fuel cell.

1. Device for the emergency electrical supply to auxiliary components (34, 35, 35a) of a nuclear power station, characterized in that it comprises at least one fuel cell (2) supplied with gas containing hydrogen and with gas containing oxygen from at least one reserve and at least one system of gas containing hydrogen and of gas containing oxygen, respectively.

2. Device according to claim 1, characterized in that in addition it comprises an intermediate device for storing electrical energy (38), placed in parallel or in series with respect to the fuel cell, in order to provide instantaneous emergency electrical current, during a phase of startup and power build-up of the fuel cell (2) or in the presence of consumption peaks.

3. Device according to claim 2, characterized in that the intermediate device for storing electrical energy consists of at least one supercapacitor (38).

4. Supply device according to claim 1, characterized in that the fuel cell is a cell of one of the following types: PEMFC, alkaline fuel cell (AFC) with or without a membrane, phosphoric acid fuel cell PAFC, molten carbonate fuel cell MCFC, solid oxide fuel cell SOFC, direct methanol fuel cell DMFC.

5. Device according to claim 1, characterized in that the fuel cell (2) is supplied with hydrogen from a supply system (12) comprising a first system part (12a) for the usual supply to systems (16a, 16b) of the nuclear power station and a second part (12b) for connecting the first part (12a) to the fuel cell.

6. Device according to claim 5, characterized in that the first system part (12a) comprises at least a tank (14) for storing pressurized hydrogen, a first stage for reducing the hydrogen pressure (15) and a first shutdown valve (15a) and in that the second part of the hydrogen supply system (12) comprises a second stage (17) for reducing the hydrogen pressure and a second shutdown valve (17a).

7. Device according to claim 5, characterized in that the system (12) for supplying hydrogen to the fuel cell (2) comprises an additional system (12c) for recycling hydrogen not consumed in the fuel cell (2).

8. Device according to claim 1, characterized in that the fuel cell (2) is supplied with hydrogen by a system specific to the fuel cell (2).

9. Device according to claim 1, characterized in that it comprises a system (24) for supplying air to the fuel cell (2) comprising a compressed-air storage buffer tank (26) of the nuclear power station connected to the fuel cell via a pipe on which a stage (27) for reducing the pressure of the compressed air (27) and a shutdown valve (27a) are placed.

10. Device according to claim 1, characterized in that in addition it comprises a system (31) for cooling the fuel cell (2) via demineralized water from a demineralized water tank (30) of the nuclear power station.

11. Device according to claim 1, characterized in that it comprises at least one system for recovering water in the fuel cell connected to a system for recovering drainage (20) from the nuclear power station.

12. Device according to claim 1, characterized in that in addition it comprises a heating device (44) to keep the fuel cell (2) at an operating temperature in order to reduce the startup time of the fuel cell.

13. Method for providing an emergency electrical supply to a drive motor of a pump for injecting water into seals of the drive shaft of a primary pump of a nuclear reactor, characterized in that, in the case of interruption of the normal electricity supply to the injection pump (35), the motor (35a) of the pump for injecting water (35) into the seals of the primary pump is supplied via a device according to any one of claims 1 to 12 and a converter (22) for converting direct current into three-phase alternating current, such as an inverter.

14. Method for providing an emergency electrical supply to at least one switchboard (40) for monitoring and controlling auxiliary components of a nuclear power station, characterized in that the switchboard (40) is supplied from current produced by a device according to any one of claims 1 to 12 and a supercapacitor plant (38) used solely to supply the board (34) or to supply several switchboards (34).

15. Method for providing an electrical supply to at least one pump for providing emergency feedwater to steam generators of the nuclear reactor, in order to cool the nuclear reactor, in the case of total loss of the electrical supply, characterized in that the pump for providing feed water is supplied with electrical current with the aid of a device according to any one of claims 1 to 12 comprising a fuel cell (2) with a power of about 500 kVA.
